(19) United States
(12) Patent Application Publication
(10) Pub. No.: US 2006/0254710 A1
(43) Pub. Date: Nov. 16, 2006

(54) Gluing Press for Lamella-Shaped Pieces of Wood and Method for Pressing such Pieces of Wood

(75) Inventors: Erhard Jung, Altenstadt (DE); Manfred Jackle, Ebershausen (DE)

Correspondence Address: GUDRUN E. HUCKETT DRAUDT, LONSSTR. 53, WUPPERTAL, 42289, DE

(73) Assignee: GRECON DIMTER HOLZOPTIMIERUNG SUD GMBH & CO. KG, Illertissen (DE)

(21) Appl. No.: 11/164,830

(22) Filed: Dec. 7, 2005

(30) Foreign Application Priority Data
Dec. 7, 2004 (DE) 10 2004 059 816.9

(51) Int. Cl. B32B 37/06; B30B 15/34; B32B 37/12

(52) U.S. Cl. 156/274.4; 156/580; 156/583.1; 156/583.9; 100/38; 100/305; 100/320

(57) ABSTRACT

A gluing press for lamella-shaped pieces of wood has a press table, a stop for the pieces of wood to be press bonded, and at least one pressing unit that presses the pieces of wood in a direction transverse to the longitudinal direction. The stop is movable in a direction toward the at least one pressing unit by a spindle drive. The stop can be adjusted easily to different board widths.

### BACKGROUND OF THE INVENTION

The invention relates to a gluing press for lamella-shaped pieces of wood (wood lamellas) comprising at least one press table, at least one stop for the pieces of wood to be press bonded, and at least one pressing unit. The invention further relates to a method for press bonding lamella-shaped glue-coated pieces of wood to boards wherein the pieces of wood are loaded in a direction transversely to their longitudinal direction by a pressing pressure.

For press bonding lamella-shaped pieces of wood to panels or boards, gluing presses are used that have a horizontal press table with a lateral pressing device as well as a lateral stop. The pieces of wood that contact one another with their longitudinal sides coated with glue are pressed against the lateral stop and press bonded. Onto the board or panel that is to be press bonded a clamping device is placed with which a vertical alignment and clamping of the lamella-shaped pieces of wood is achieved. Since the boards or panels to be produced usually have different widths and thickness, the gluing presses must be adjusted in a time-consuming and complex way because a plurality of pressing elements must be fitted or mounted. For certain pressing widths it is necessary to employ auxiliary pieces of wood. The pieces of wood resting against the fixed stop are loaded at the opposite side by means of pressing cylinders with appropriate pressing elements that must be exchanged individually when resetting the gluing press to a different board or panel width and/or board or panel thickness. Because the stroke length of these pressing cylinders is limited, the board width is also limited.

### SUMMARY OF THE INVENTION

It is an object of the present invention to configure a gluing press as well as a method of the aforementioned kind such that boards or panels of different width and/or thickness can be produced in an inexpensive and simple way.

In accordance with the present invention, this is achieved in that the stop is movable in the direction toward the pressing units. In accordance with the present invention this is achieved in regard to the method in that the pieces of wood are first aligned transversely to their longitudinal direction and subsequently are press bonded by a force that is generated by a pressure medium.

In the gluing press according to the present invention, the pieces of wood are pushed by means of the stop against the pressing unit. Since the stop is movable in the pressing direction or opposite to the pressing direction, it can be adjusted in a simple and fast way to different board or panel widths without impairing the stability of the stop. The pressing unit itself requires only a minimal pressing stroke in order to apply the pressing force onto the pieces of wood. The pressing force is generated in that a pressure medium is pressurized during the pressing step so that the pressing pressure required for press bonding the pieces of wood is generated.

### BRIEF DESCRIPTION OF THE DRAWING

FIG. 1 is a perspective illustration of a gluing press according to the invention.

FIG. 2 shows in an illustration in accordance with FIG. 1 the partially open gluing press.

FIG. 3 shows the gluing press of FIG. 1 in a completely open position.

FIG. 4 is a side view of the gluing press according to the invention in a partially opened state.

FIG. 5 shows in a perspective illustration the gluing press according to the invention and an upstream loading device in a loading position.

FIG. 6 shows in an illustration according to FIG. 5 the gluing press according to the invention with the lid in the open position and the loading device in the feeding position.

FIG. 7 is a plan view onto the clamping elements of a lid of the gluing press according to the invention.

FIG. 8 shows in a perspective illustration the clamping elements of the lid of the gluing press according to the invention.

FIG. 9 shows in a side view a part of the clamping elements of the lid of the gluing press according to the invention.

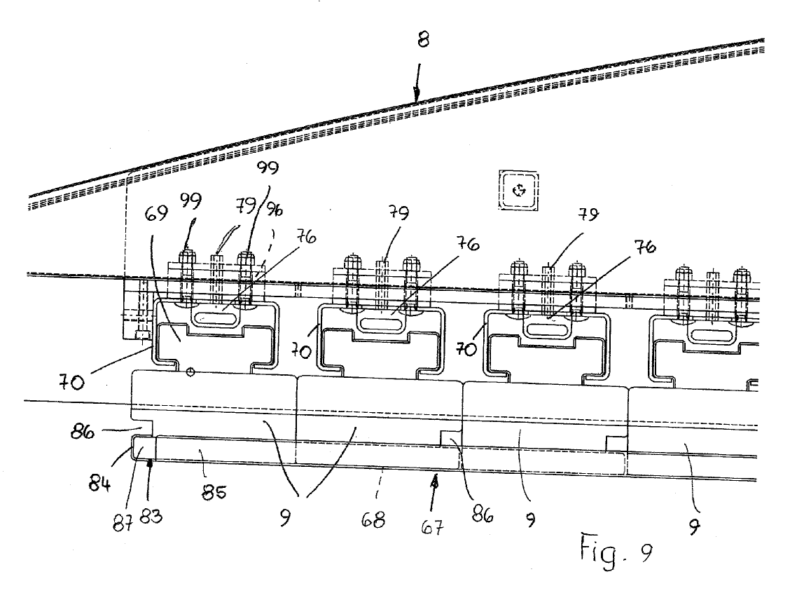

FIG. 10 is an enlarged side view of one of the clamping elements of the lid of the gluing press according to the invention.

FIG. 11 is a side view of the pressing elements as well as of a part of the lid of the gluing press according to the invention in its partially open state.

FIG. 12 is a side view of a stop arranged on the press table of the gluing press according to the invention.

FIG. 13 is an illustration in accordance with FIG. 10 showing the stop in a partially lifted state.

FIG. 14 is a rear view of the gluing press according to the invention.

FIG. 15 is a bottom view at an angle of a part of the press table of the gluing press according to the invention.

FIG. 16 is a perspective illustration of a drive unit for height adjustment of the lid of the gluing press according to the invention.

### DESCRIPTION OF THE PREFERRED EMBODIMENTS

The gluing press serves for producing boards/panels and square beams of lamella-shaped solid pieces of wood (wood lamellas). These solid pieces of wood (wood lamellas) are coated with glue on the sides resting against one another and then press bonded.

The gluing press has a frame 1 on which a horizontal press table 2 is disposed. The pieces of wood 3 to be press bonded rest on it during the pressing step. The press table 2 has a flat support surface 4 which is delimited along one longitudinal side by adjacently positioned pressing elements 5 of a pressing unit. On the opposed longitudinal side, for example, there is a stop in the form of two linear or straight stop bars 6 that are aligned flush with one another; the stop bars 6 are provided for moving the pieces of wood 3 transversely to the longitudinal direction of the support surface 4 against the pressing unit comprised of pressing elements 5. Depending on the size of the press table 2, only one or more than two stop bars 6 can be provided. These stop bars 6 are designed to move in a way to be described in the following transversely to the longitudinal direction of the support surface 4. For guiding the stop bars 6 on the support surface 4, parallel positioned slots 7 are provided in the support surface 4; they extends from the longitudinal side opposite the pressing elements 5 proximately across half the width of the support surface 4. By means of the stop bars 6 a very simple adjustment to the required width of the board to be produced from the pieces of wood 3 is possible. The stop bars 6 extend as a whole across the length of the support surface 4 so that they can be used entirely for press bonding the pieces of wood 3 (wood lamellas). For example, for a possible pressing width of, for example, 1,200 mm of the boards up to a width of 600 mm, several stop bars 6 can be placed adjacent to one another across the gluing press. In this way, the pressing area can be used optimally. The slots 7 extends advantageously across half the width of the support surface 4. The stop bars 6 are designed to be removable from the press table 2. In this way, a simple adjustment of the stop bars 6 to pieces of wood 3 of different thickness is ensured. Depending on the thickness of the pieces of wood 3 to be bonded, stop bars of different height are inserted into the press table 2.

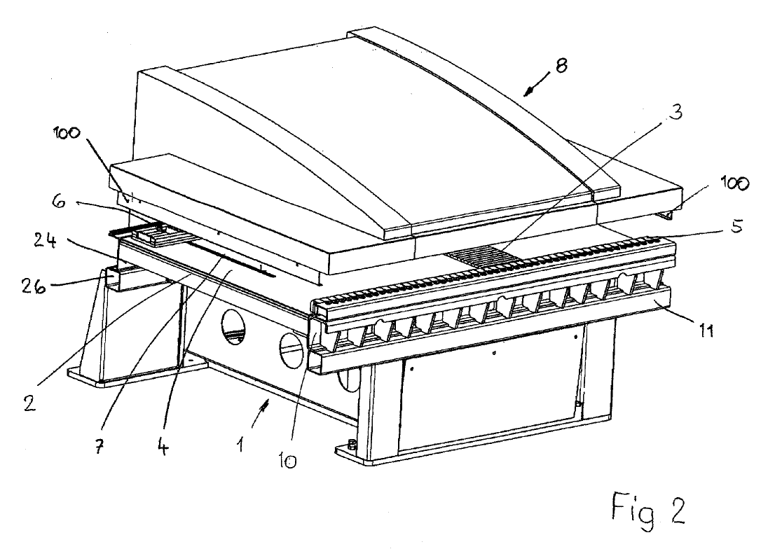

The pieces of wood 3 resting against one another with their glue-coated sides are moved by the stop bars 6 until they contact the pressing elements 5. Before the pressing pressure is generated, a clamping device in the form of a lid 8 is lowered from its open position (FIGS. 2 to 4) into its closed position. The clamping device (lid) 8 is provided at its bottom side with adjacently positioned clamping elements (pressing bars) 9 that rest on the pieces of wood 3 and align them relative to one another in the horizontal direction upon appropriate pressure loading. Subsequently, the pressure acting on the pressing elements 5 is generated. By means of this pressing pressure, the pieces of wood 3 are press bonded. They are supported by the stop bars 6 during the pressing process in a proper way. For curing the glue between the pieces of wood 3, the lid 8 is provided with a heating device that during the pressing step is switched on and causes the glue to cure.

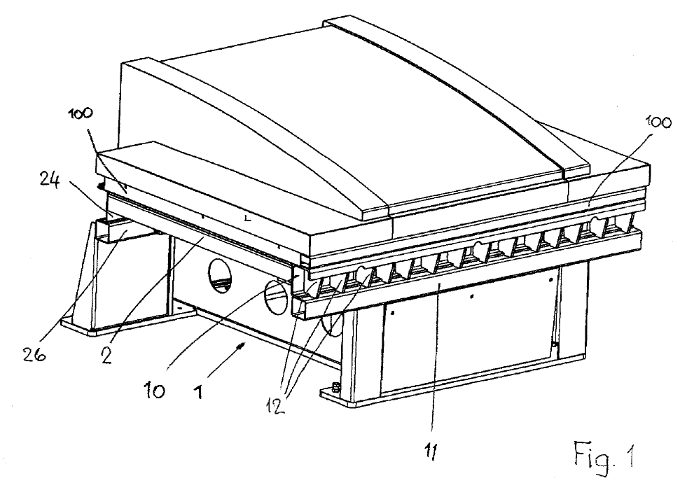

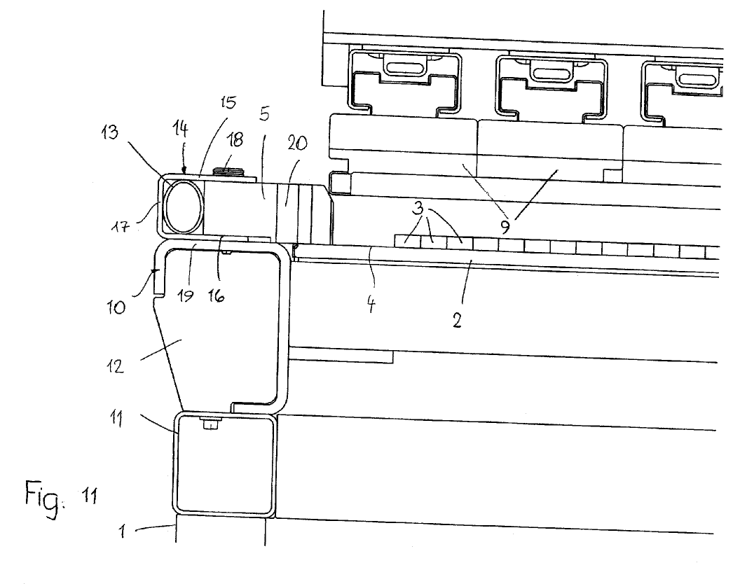

The pressing elements 5 are supported on a longitudinal support 10 that is positioned on a longitudinal side of the press table 2 and is formed by a profiled rail (FIG. 11). The longitudinal support 10 is fastened on a frame support 11 of the frame 1 that is configured as a square tube. The longitudinal support 10 and the frame support 11 are positioned on top one another and are advantageously of the same length. Distributed across the length of the longitudinal support 10 there are reinforcement elements 12 (FIGS. 1 through 4) that are arranged completely within the contour of the longitudinal support 10.

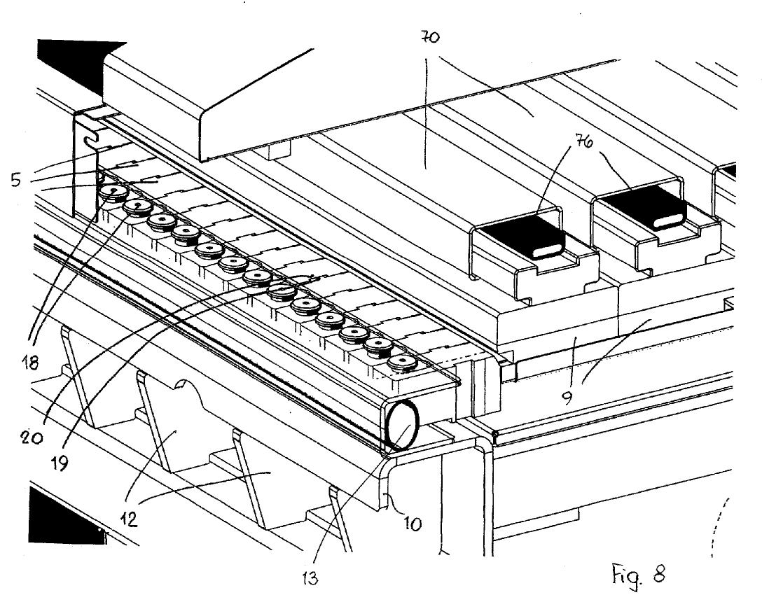

The pressing elements 5 are movable in the direction toward the stop bars 6 to a limited extent. The side of the pressing elements 5 that is facing away from the stop bars 6 rests against a flexible hose 13, respectively (FIG. 8 and FIG. 11). The flexible hose 13 is closed at both ends and is connected to a compressed air source. The hose 13 extends across the length of the longitudinal support 10 and is received in a securing rail in the form of a U-shaped part 14 that is fastened on the longitudinal support 10. The two horizontal legs 15, 16 of the U-shaped part 14 extend in the direction toward the stop bars 6. The transverse web 17 connecting the two legs 15, 16 extends vertically and covers the hose 13 so that it is protected against damage. It is positioned between the web 17 of the U-shaped part 14 and the pressing elements 5 that project partially into the space between the legs 15, 16. The pressing elements 5 extend down to the support surface 4 of the press table 2. Screws 18 or the like pass through the pressing elements 5 and also pass through the legs 15, 16 of the U-shaped part 14 as well as the upper horizontal leg 19 of the longitudinal support 10. The passages in the pressing elements 5 for the screws 18 are so large that the pressing elements 5 can be moved to a limited extent in the pressing direction.

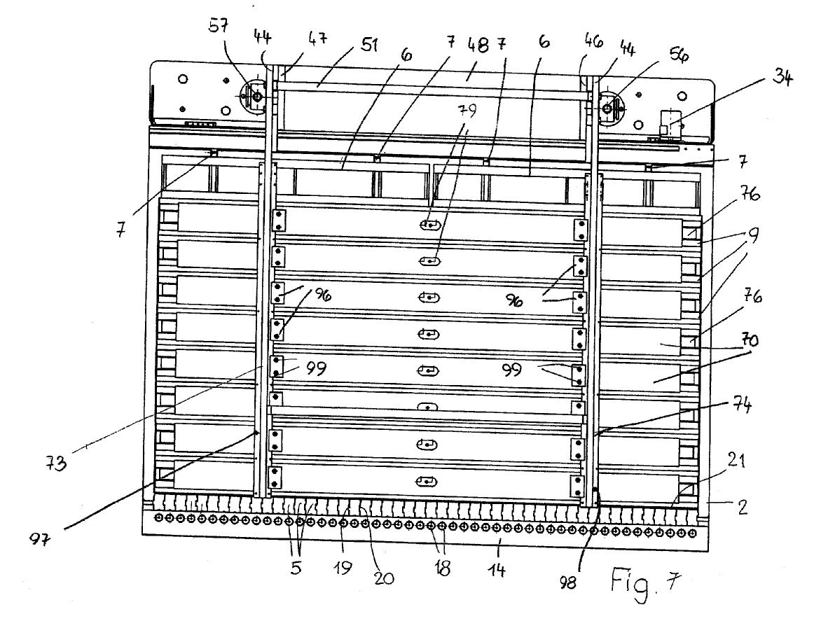

As can be seen in FIGS. 7 and 8, the pressing elements 5 are block-shaped and contact one another. The pressing elements 5 are provided at one side with a projecting tongue 19 that extends across the height of the pressing elements and at the opposed side with a matching recess (groove) 20. The adjacently positioned pressing elements 5 engage with the tongue 19 the recess or groove 20 of neighboring pressing element 5, respectively. In this way, the pressing elements 5 positioned adjacent to one another are properly aligned with one another. This positive-locking connection is designed such that neighboring pressing elements 5 can still move minimally relative to one another.

As shown in FIG. 2, the pressing elements 5 are significantly smaller than the pieces of wood 3 to be press bonded. For this reason, the individual pressing elements 5 can adjust optimally to the pieces of wood 3 or the board/panel to be produced from the pieces of wood 3. The plurality of pressing elements 5 forms a multi-slide bar against which the wood lamellas 3 rest during the press bonding step. As illustrated in FIG. 7, the pressing elements 5 form a continuous stop surface 21 for the pieces of wood (wood lamellas) 3. Since the plurality of pressing elements 5 can adjust flexibly to the pieces of wood 3, it is even possible to press bond pieces of wood 3 having so-called gap joints so that a proper press bonding of the pieces of wood 3 is ensured.

The height of the pressing elements 5 is matched to the maximum height of the pieces of wood 3 that are to be press bonded and extend parallel to the multi-slide bar.

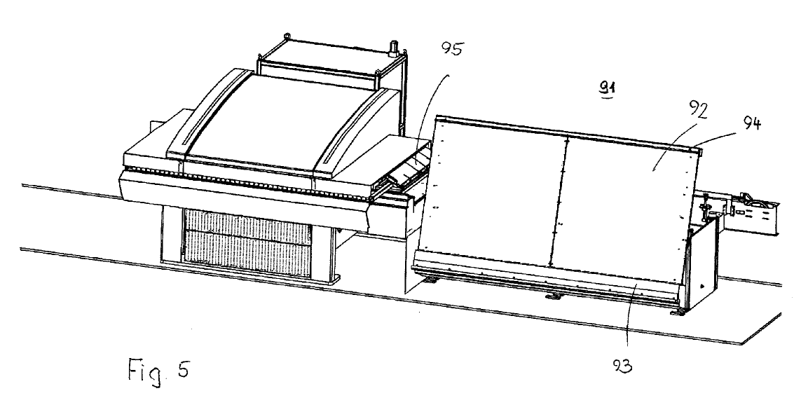

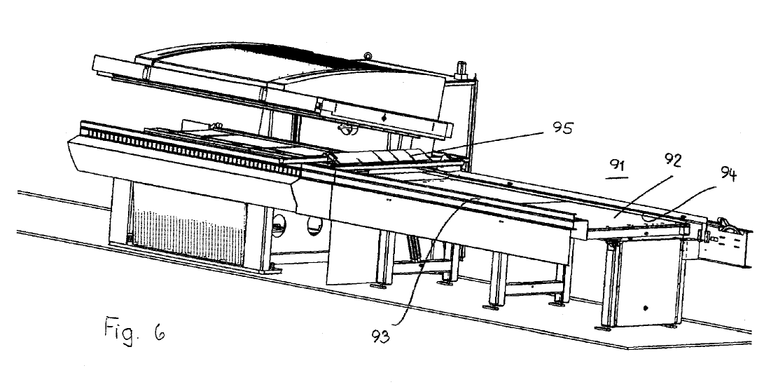

After application of the glue to their longitudinal sides, the pieces of wood 3 are moved in the direction of the longitudinal extension onto the press table 2. For this purpose, the gluing press has upstream thereof a loading unit 91 (FIGS. 5 and 6). The loading unit 91 has a support table 92 that is pivotable about a horizontal axis. FIG. 5 shows the support table 92 in the pivoted or tilted position in which the pieces of wood 3 to be press bonded with one another can be easily placed onto the support table 92. The support table 92 is delimited at both longitudinal edges by a profiled rail 93, 94, respectively. The pieces of wood 3 to be press bonded are placed or stacked onto the profiled rail 93 that is positioned at the lower end of the tilted support table 92. Since the support table 92 can be tilted, a simple loading action is ensured.

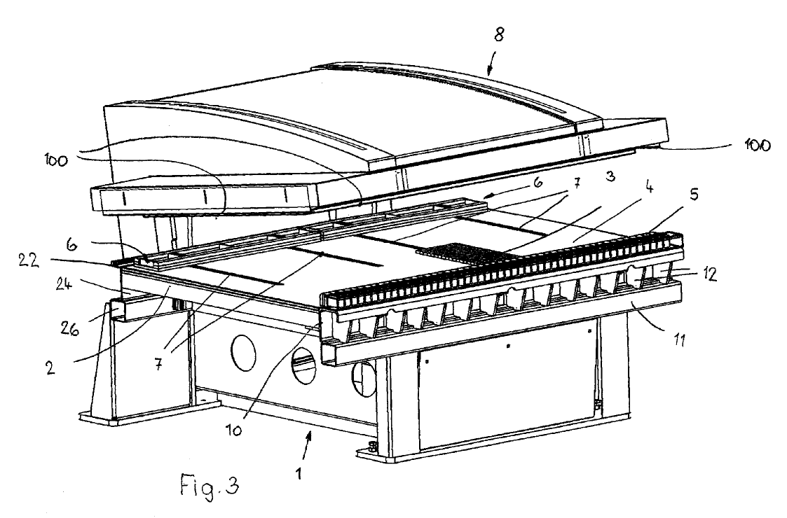

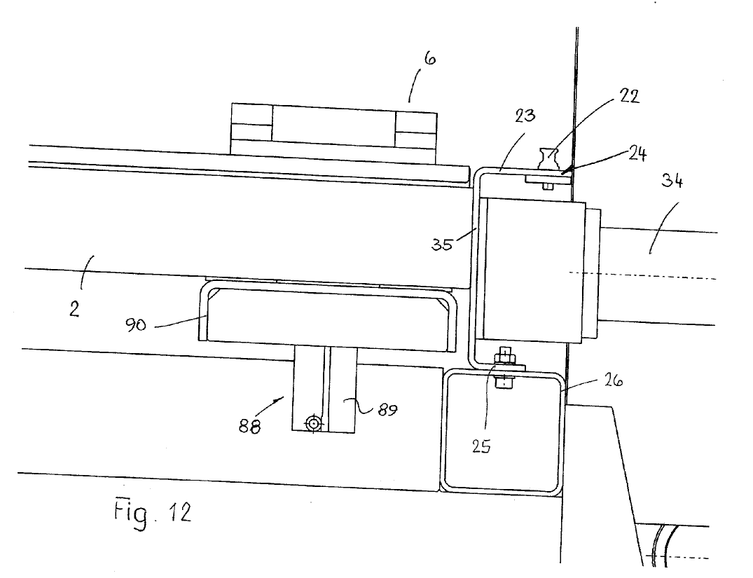

For moving the lamella package that is combined on the support table 92, a slide 95 is provided that can be moved along a linear guide 22. The linear guide 22 extends along the longitudinal side of the press table 2 that is opposite the pressing elements 5 and the profiled rail 93 in the longitudinal direction of the sequentially positioned pressing elements 5 (FIGS. 3, 4, 12, and 13) and of the support table 92. The linear guide 22 is positioned in the area of the press table 2 on a horizontal leg 23 of a U-shaped longitudinal support 24 that extends parallel to the longitudinal support 10 on the opposite longitudinal edge of the press table 2. The longitudinal support 24 is connected by means of its other horizontal leg 25 to a frame support 26 that extends parallel to the frame support 11. The linear guide 22 extends also across the length of the support table 92 so that the slide 59 can be moved to the side of the support table 92 that is facing away from the gluing press.

The support table 92 advantageously adjoins without any gap the press table 2 so that the pieces of wood 3 can be moved by means of the slide 95 without problems from the support table 92 onto the press table 2. The slide 95 is supported on a carriage that can be moved on the linear guide 22. In order for the slide 95 to move across the pieces of wood 3 placed onto the support table 92 when being returned, the slide 95 is connected to the carriage so as to be pivotable about a horizontal axis that extends in the moving direction. The slide 95 can therefore be moved in an upwardly pivoted position across the pieces of wood 3 and can be lowered again when located behind them. When the slide 95 is subsequently moved again in the direction toward the gluing press, it entrains the pieces of wood 3. In this way, while the slide 95 moves toward the press table 2, the next lamella package can be combined on the support table 92.

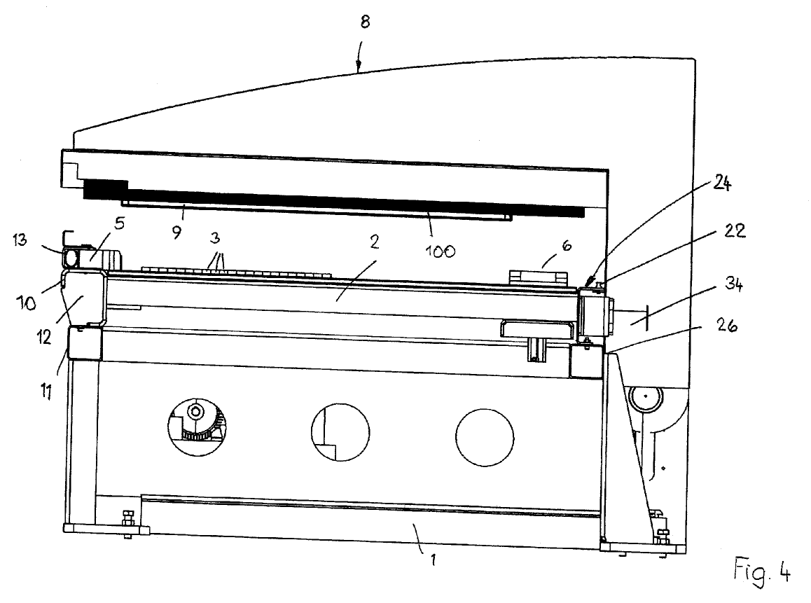

The frame supports 11, 26 and the longitudinal supports 10, 24 are positioned at the same level (FIG. 4). The press table 2 is fastened between the longitudinal supports 10, 24. By means of the slide 95 the pieces of wood 3 can be moved in their longitudinal direction into the pressing area and, after the pressing process, they can be pushed out of it. Since filling of the gluing press is realized in the longitudinal direction of the press table 2 and thus perpendicularly to the pressing direction, a simple and quick filling of the gluing press is ensured. After the movement of the pieces of wood 3 resting against one another into the gluing press, the stop bars 6 are moved transversely to the insertion direction onto the press table 2 to such an extent until the pieces of wood 3 rest against or contact the pressing elements 5. In FIGS. 4 and 11, the pieces of wood 3 are still spaced from the pressing elements 5. The pieces of wood 3 are moved on the support surface 4 of the press table 2 in the described way by means of the stop bars 6 until they contact the pressing elements 5. The pressing elements 5 are completely extended in the direction toward the support surface 4. For this purpose, the hose 13 is filled with compressed air. It expands accordingly and moves thus the pressing elements 5 into the completely extended position. For this purpose, a minimal pressure of the pressure medium within the hose 13 is sufficient. When the pieces of wood 3 are moved by the stop bars 6 against the pressing elements 5, the pressing elements 5 can move slightly relative to one another, depending on the configuration or course of the contacting edge of the pieces of wood 3. The elastically deformable hose 13 ensures that the pressing elements 5 rest against the edge of the pieces of wood 3.

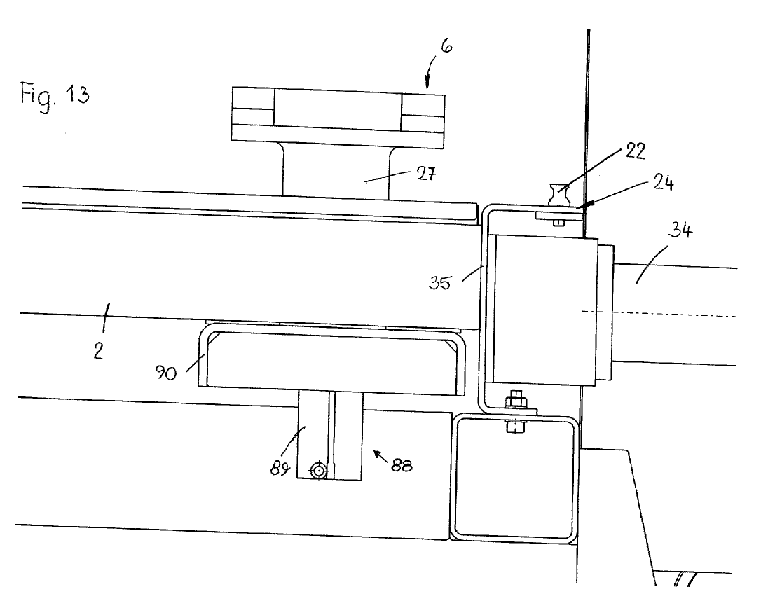

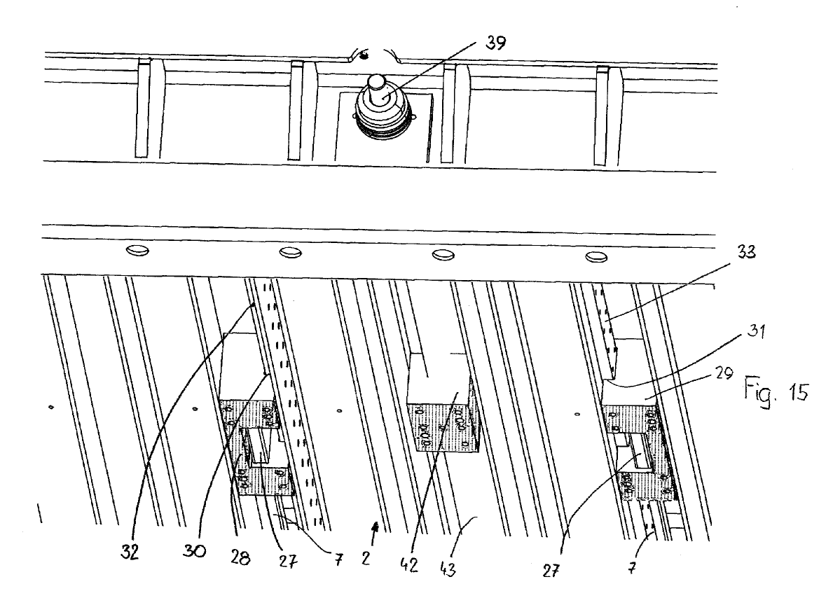

The stop bars 6 extend parallel to the linear guide 22 (FIGS. 2 to 4) and engage by means of blades 27 provided at the bottom side the slots 7 of the press table 2 (FIG. 13). The stop bars 6 have advantageously two such blades 27 near their ends, respectively. As can be seen in FIG. 15, these blades 27 are connected positive lockingly to supporting means including carriages 28, 29 (plug connection); the carriages 28, 29 are provided on a frame (not illustrated) that is slidably arranged on the bottom side of the press table 2. The carriages 28, 29 are guided in the slots 7 in a positive-locking way. On their sides facing one another, the carriages 28, 29 are provided with receptacles 30, 31 embodied as a recess and extending across the length of the carriage. A guide bar 32, 33 attached to one side wall of the slot 7 engages the recesses 30, 31.

In FIG. 15 only the neighboring carriages 28, 29 of the two stop bars 6 are illustrated. Corresponding carriages are provided at the other ends of the stop bars 6.

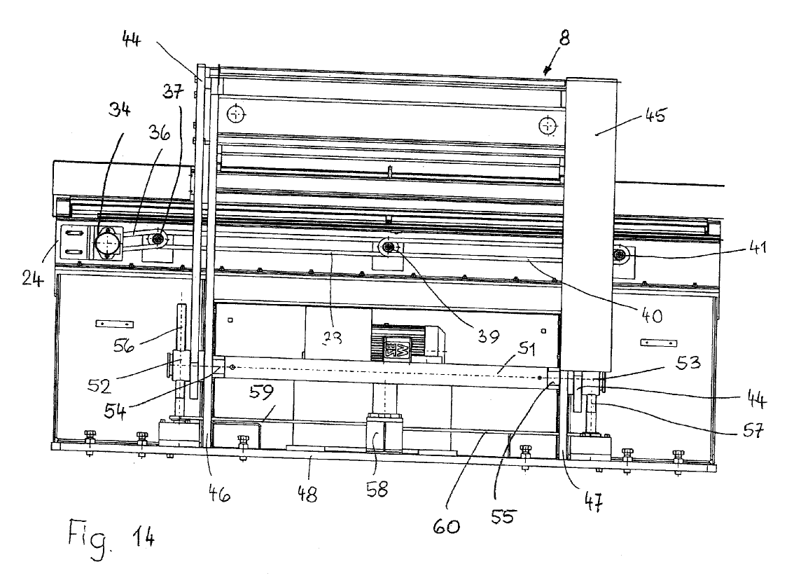

For driving the stop bars 6 a hydromotor 34 is provided that is arranged at one end of the gluing press (FIG. 14). The hydromotor 34 is attached to a vertical bar 35 of the longitudinal support 24. Employing a hydromotor provides the possibility of adjusting in a simple way the speed and the feeding forces of the stop bars 6 by means of throttles and pressure reducers.

As shown in FIG. 14, the hydromotor 34 is drivingly connected by an endless drive 36 to a spindle 37. The spindle 37, in turn, is drivingly connected by an additional endless drive 38 to the spindle 39 that, in turn, is drivingly connected by endless drive 40 to a spindle 41. The spindles 37, 39, 41 are positioned parallel to one another and extend in the moving direction of the stop bars 6. The spindles 37, 39, 41 are rotatably supported in the press table 2. As illustrated in FIG. 15 for the spindle 39, a spindle nut 42 is positioned on the spindles and is moved by rotation of the spindle in the respective direction. The spindle nut 42 is guided to be slidable in the longitudinal direction in a recess 43 provided at the bottom side of the press table 2. In this way, it is ensured that the spindle nut 42 will not rotate about its axis but is reliably moved. On the other spindles 37 and 41 a corresponding spindle nut is positioned, respectively, that is fixedly connected to the spindles in the moving direction of the stop bars 6 by means of the frame. The stop bars 6 engage with their blades 27 the corresponding carriages. By means of the common hydromotor 34 both stop bars 6 are thus simultaneously moved by the same amount.

The edge of the lid 8 that is facing away from the pressure elements 5 is supported in a height adjustable way on the frame 1. The lid 8 has at both ends a plate-shaped vertical lid support 44. The plate-shaped vertical lid supports 44 are positioned underneath a protective cover 45; FIG. 14 shows only one of them.

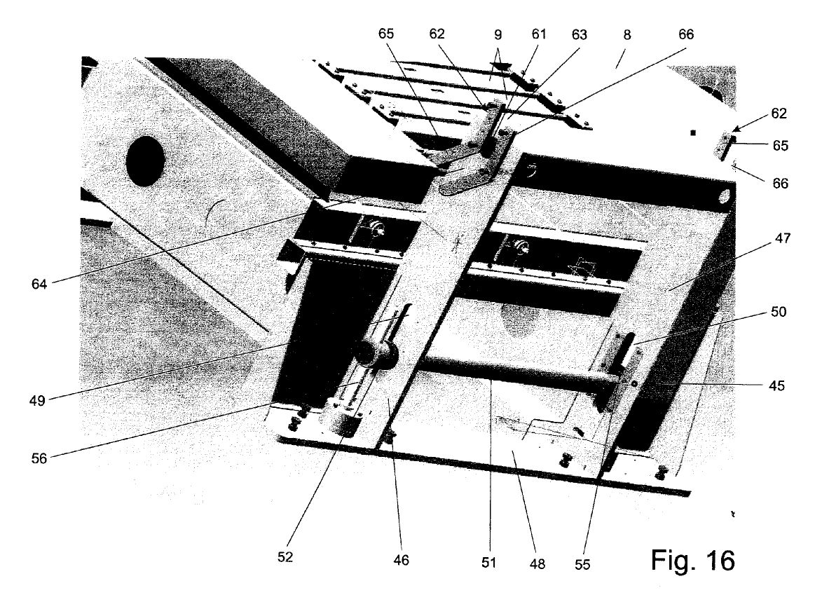

The lid support 44 is positioned parallel to the plate-shaped supports 46, 47 that are fastened with their lower end to a base plate 48 of the frame 1. In FIG. 16 only the supports 46, 47 are illustrated but not the lid supports 44 of the lid 8. Each one of the supports 46, 47 that extend parallel to one another has a slotted hole 45, 50 extending in the vertical direction, respectively. Between the supports 46, 47 a transverse support in the form of a pipe 51 is provided that is connected to the lower ends of the lid supports 44. Across the length of the slotted holes 49, 50, the pipe 51 can be vertically adjusted to a limited extent.

As can be seen in FIG. 14, onto the two ends of the pipe 51 spindle nuts 52, 53 are placed by means of plug-on or snap-on projections 54, 55. They have a cross-section that is not round and is preferably angular and is seated fixedly in the pipe 51. The projections 54, 55 penetrate the vertical lid supports 44 as well as the slotted holes 49, 50 provided in the supports 46, 47. The spindle nuts 52, 53 are positioned at the outer sides of the lid supports 44 that face away from one another. The lid supports 44 are arranged at a minimal spacing next to the outer sides of the supports 46, 47 that face away from one another. The spindle nuts 52, 53 are seated on vertical spindles 56, 57 that are rotatably supported on the base plate 48. The drive of the spindles 56, 57 is realized by a hydromotor 58 that is mounted in the area between the two supports 46, 47 on the base plate 48. The spindles 56, 57 are driven by means of two chain drives 59, 60 by the hydromotor 58. Depending on the rotational direction of the spindles 56, 57, the lid 8 is adjusted upwardly or downwardly by the lid supports 44.

The use of the spindle 56, 57 for height adjustment of the lid 8 has the advantage that only a minimal force is required for adjusting the lid. By providing a self-locking action of the spindle thread, it is possible to apply large clamping forces. Moreover, the spindle drive is reliable. The self-locking spindle thread prevents also that the lid 8 drops downwardly.

The projections 54, 55 are guided in the slotted holes 49, 50 by slide bearings or roller bearings so that an easy movability is ensured.

As shown in FIG. 16, near the upper end of the supports 46, 47 a sliding block 61 is provided that is advantageously in the form of a freely rotatable roll. The lid 8 is provided with guides 62 in which the respective sliding blocks 61 engage. The guides 62 have guiding means in the form of an upper vertically extending guide section 63 and a slanted guide section 64 adjoining the guide section 63 in the downward direction. As an example, the guides 62 can be formed by parallel extending obtusely angled bars 65, 66 connected to the inner side of the lid supports 44.

When the lid 8 is in its lower closed position, the sliding blocks 61 are located in the vertical guide sections 63 of the guides 62. When the lid supports 44 are moved by actuation of the spindles 56, 57 in the upward direction, the lid 8 remains initially in its horizontal position as long as the sliding blocks 61 are located in the vertical guide sections 63. Upon further lifting of the lid 8, the sliding blocks 61 reach the slanted guide section 64 so that the lid 8 is moved from its horizontal open position (FIG. 2) upon further height adjustment into a slanted open position (FIG. 3). The thus described height adjustment causes the lid 8 to be pivoted rearwardly at the end of its adjusting stroke. In this way, the press bed is easily accessible. The lid supports 44 pivot for this opening movement about the axis of the pipe 51. The maximum displacement stroke of the lid 8 is determined by the length of the slotted holes 49, 50.

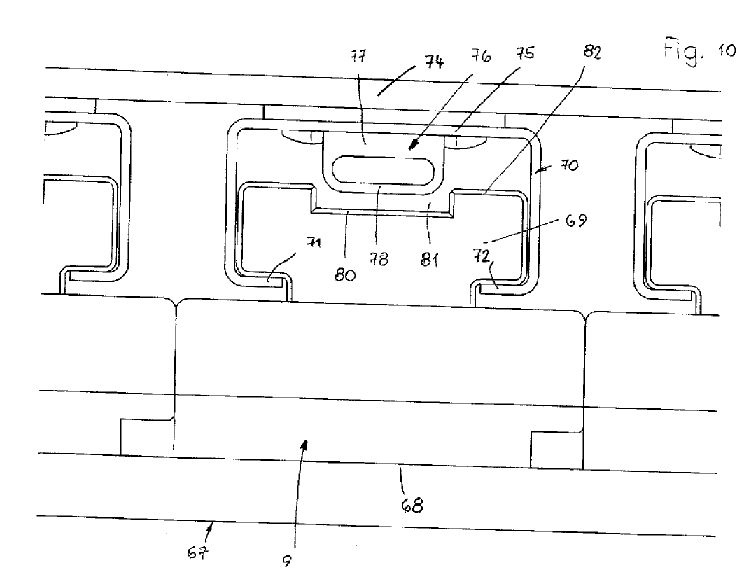

The pressure bars 9 connected to the bottom side of the lid 8 form a pressing platen 67 that during the pressing step rests on the pieces of wood 3 of the board to be press bonded. The pressing bars 9 extend parallel to the pieces of wood 3 almost across the entire length of the press table 2 (FIG. 7). The pressing bars 9 have a plane bottom side 68. At half their width a profiled securing member 69 projects upwardly from the pressing bars 9, respectively. It is secured in a C-shaped profiled holding rail 70, respectively. The leg ends 71, 72 (FIG. 10) facing one another are positioned at the same level and engage the bottom of the respective profiled securing member 69. The profiled holding rails 70 are somewhat shorter than the pressing bars 9 (FIG. 7 and FIG. 8) and are attached to two transverse beams 73, 74 that are positioned at a spacing relative to one another. The beams 73, 74 are secured, in turn, to the bottom side of the lid 8. On the inner side of the stay 75 of the profiled holding rails 70 a hose 76 is attached, respectively. It has an approximately rectangular cross-section and is positioned with a thicker wall 77 at the inner side of the stay 75 of the profiled holding rails 70. The opposed wall 78 of the hose 76 facing the pressing bars 9 is thinner (see FIG. 10). The hoses extend across approximately the length of the pressing bars 9 and are closed at their two ends. Approximately at half their length, the hoses 76 are provided with a connector 79 (FIG. 7) with which the hoses 76 can be connected to a compressed air of source.

When the lid 8 is lifted (FIG. 2 and FIG. 3), the pressing bars 9 are suspended with their profiled members 69 on the leg ends 71, 72 of the profiled holding rails 70 (FIG. 10). In this position, the hose wall 78 is spaced from the bottom 80 of a recess 81 provided in the topside 82 of the profiled member 69 which topside is facing the stay 75 of the profiled holding rails 70. The width of the recesses 81 measured transversely to the longitudinal direction of the pressing bars 9 corresponds approximately to the corresponding width of the hose 76. When the lid 8 is lowered from the open position by means of the spindles 56, 57 in the described way, the pressing platen 67 contacts the pieces of wood 3. The hoses 76 are filled with the pressure medium. Since the pressing bars 9 are supported so as to be vertically movable independent from one another to a limited extent in the profiled holding rails 70, they can adjust optimally to the topside of the board to be press bonded. Because of the pressurized hoses 76, the individual pressing bars 9 are additionally pushed downwardly so that the alignment of the lamella-shaped pieces of wood 3 is even more improved. By means of the hoses 76 filled with compressed air, the required clamping force is applied to the pieces of wood 3 during the pressing step. The leg ends 71, 72 of the profiled holding rails 70 have in the suspended position of the pressing bars 9 a sufficiently large spacing from their topside so that, after the pressing bars 9 contact the pieces of wood 3 and upon a further lowering of the lid 8 and thus of the profiled holding rails 70, the profiled members 69 come into contact with the hoses 76 before the leg ends 71, 72 contact the pressing bars 9. In this way, a sufficiently high clamping pressure (clamping force) can be generated in the clamping direction transverse to the pressing direction of the pressing unit.

The pressing bars 9 are covered at their bottom side 68 by a plate-shaped or flat heating electrode 83 with which the pressing platen 67 during the pressing step rests on the pieces of wood 3. On the longitudinal sides 84 the electrode 83 is bent to a U-shape. On the narrow sides 85 the electrode 83 is angled upwardly at a right angle. The pressing bars 9 rest with their narrow sides against the angled narrow sides 85 of the electrode 83. The pressing bars 9 located on the longitudinal sides of the press table 2 are provided with a groove 86 extending across the length of the pressing bars; the groove 86 is delimited in the direction toward the bottom side 68 of the pressing bars 9 by a continuous stay 87 (uninterrupted over its length). The stay 87 is engaged by the U-shaped longitudinal side 84 of the flat electrode 83. In this way, the flat electrode 83 is secured safely on the pressing platen 67.

Advantageously, all pressing bars 9 are provided with the described groove 86 so that each pressing bar 9 can be used as a suspending strip for the electrode 83. Current is supplied during the pressing step to the electrode 83 that covers the bottom side of the pressing platen 67 completely. The press table 2 or the frame 1 function as ground (minus pole). The electrode 83 is part of a high frequency heating device with which during the pressing step the glue between the lamella-shaped pieces of wood 3 is cured. The pressing bars 9 are comprised of electrically insulating materials such as wood, plastic material and the like.

External to the press table 2 within the loading unit 91, the lamella-shaped pieces of wood 3 are placed next to one another so that their glue-coated longitudinal sides rest against one another. By means of the slide 95 the package that is combined in this way is pushed onto the press table 2. The slide 95 is moved along the linear guide 22. Since the linear guide 22 extends across the entire length of the press table 2, the slide 95 can be moved to the end of the press table 2 so that by means of the slide 95 after the press bonding step the bonded pieces of wood 3 can be pushed completely off the press table 2. During this loading process of the press table 2, the stop bars 6 are advantageously in their initial or starting position in which they have the greatest spacing from the opposed pressing elements 5 (FIG. 3). Of course, it is possible to adjust the stop bars 6 in the direction toward the pressing elements 5 when the length of the board to be press bonded is accordingly small. The lamella-shaped pieces of wood 3 are pushed onto the press table 2 in such a way that they extend parallel to the pressure bar that is comprised of the pressing elements 5 (FIG. 3). Depending on the length of the pieces of wood 3, several packages can be pushed sequentially onto the press table 2. During this insertion process the hose 13 extending across the length of the pressure bar is filled with compressed air.

The stop bars 6 are moved subsequently on the press table 2 by means of the hydromotor 34 and the spindles 37, 39, 41 in the direction toward the pressing elements 5. By means of the stop bars 6 the combined boards are pressed against the pressing elements 5. Since across the length of the pieces of wood 3 a plurality of pressing elements 5 are provided that can be moved relative to one another to a limited extent, it is ensured that the pressing elements 5 rest optimally at the corresponding edge of the board to be press bonded. By means of the spindles 37, 39, 41 the frame that is positioned underneath the press table 2 is moved, powered by motor 34, to the corresponding pressing width. By means of the spindles 37, 39, 41 the pressure force can be taken up properly during the pressing step. The spindles 37, 39, 41 are provided with a self-locking thread so that the stop bars 6 can support the pieces of wood 3 safely against the pressing force. For generating the pressing force, the pressure medium in the hose 13 of the pressing elements 5 is pressurized to such a high pressure that in this way the pressing elements 5 are forced against the package to be pressed with an appropriate force. The spindles 37, 39, 41 can take up the pressing force properly. Since the stop bars 6 move the pieces of wood 3 against the pressing elements 5 the pressing elements 5 must perform only a minimal pressing stroke for the pressing step. Because of the plurality of pressing elements 5 is also ensured that the pieces of wood 3 must not be aligned precisely relative to the pressing elements 5.

Before the pressing pressure is generated, the clamping device in the form of the lid 8 is closed in the described way by motor power. The pressing bars 9 with the flat electrode 83 come to rest on the lamella-shaped pieces of wood 3 of the package so that they are vertically aligned. The clamping elements in the form of pressing bars 9 are moved downwardly in the described way by the hoses 76 so that the vertical alignment of the lamella-shaped pieces of wood 3 is even more improved. As soon as this clamping pressure has been generated, the pressing pressure is generated by the described increase of the pressure in the hose 13 so that the pieces of wood 3 are press bonded transversely to their longitudinal direction at a high force. By means of this high pressing pressure the pieces of wood 3 are pressed against one another and are therefore moved minimally in the pressing direction. When doing so, the pressing bars 9 resting on top of the pieces of wood 3 are entrained minimally. For this purpose, the profiled rails 70 are provided with two securing tabs 96 (FIG. 7) that engage across plates 97, 98 fastened to the bottom side of the transverse beams 73, 74. The plates 97, 98 are longer than the pressing platen 67. The securing tabs 96 with the pressing bars 9 connected thereto by screws 99 are moveable somewhat in the longitudinal direction of the transverse beams 73, 74 and thus are movable in the pressing direction. Since the pressing bars 9 rest under the clamping pressure on the pieces of wood 3 that are moved minimally on the contact surface 4 of the press table 2 in the direction toward the stop bars 6 under the pressing pressure, the resulting friction force can be optimally received and dissipated.

During the pressing step high frequency heating is switched on so that the glue between the pieces of wood 3 can cure quickly. In order for the radiation that results from high frequency heating not reach the exterior, on the edge of the lid 8 skirts 100 are attached (FIGS. 1 through 4) that shield the pressing area relative to the high frequency radiation when the lid 8 is lowered (FIG. 1). The skirts 100 close the gap between the support surface 4 of the press table 2 and the bottom side of the lid 8.

After termination of this pressing step the pressure in the hose 13 is reduced and the lid 8 is lifted off the press table 2 by means of the hydromotor 58 and the spindles 56, 57. Simultaneous to the lifting of the lid 8 or subsequently thereto, the stop bars 6 are retracted to such an extent that the slide 95 can push the press bonded board away from the press table 2. Expediently, the press bonded board is pushed off the press table 2 by the next wood package that is being pushed onto the press table 2.

Depending on the height of the lamella-shaped pieces of wood 3, stop bars having different heights are used. Since they must only be pushed with their blades 27 into the carriages 28, 29 of the drive frame, an exchange of the stop bars 6 is simple and fast. In order to facilitate this exchange, a lifting device 88 is provided (FIGS. 10 and 11) for the stop bars 6. It comprises a lifting cylinder 89, preferably a pneumatic cylinder, that is secured on a longitudinal support 90 that is attached to the bottom side of the press table 2. The piston rod (not illustrated) of this lifting cylinder 89 engages when being extended the bottom side of the blades 27 of the stop bars 6 so that they are lifted into a removal position (FIG. 11). In this way, a simple and easy exchange of the stop bar 6 is possible.

When the product to be made is to be changed, the stop bars 6 can therefore be easily exchanged. Also, the pressing pressure and the high frequency generator of the high frequency heating device can be adjusted in a simple way to the product, respectively.

The pressing bars 9, in deviation from the illustrated embodiment, can also be comprised of two or more bar sections arranged sequentially behind one another and contacting one another directly.

Advantageously, the stop bars 6 and the lid 8 are moved to such an extent that the pressure in the hoses 13, 76 reaches a predetermined value. This pressure of the pressure medium in the hoses 13, 76 can be monitored in a simple way. As soon as the pressure has been reached, the adjustment movement is terminated so that the stop bars 6 and the lid 8 are stopped in their respective positions.

It is also possible to control the adjustment of the stop bars 6 and/or of the lid 8 as a function of time or travel (stroke) distance.

While specific embodiments of the invention have been shown and described in detail to illustrate the inventive principles, it will be understood that the invention may be embodied otherwise without departing from such principles.

What is claimed is:

1. A gluing press for lamella-shaped pieces of wood, the gluing press comprising:
a press table;
a stop for pieces of wood to be press bonded;
at least one pressing unit;
wherein the stop is movable in a direction toward the at least one pressing unit.

2. The gluing press according to claim 1, wherein the stop is adjustable by a motor drive.

3. The gluing press according to claim 1, further comprising a spindle drive connected to the stop, wherein the stop is adjusted by the spindle drive.

4. The gluing press according to claim 3, further comprising a hydromotor that is drivingly connected to the spindle drive.

5. The gluing press according to claim 1, further comprising a clamping device applying, during pressing of the pieces of wood by the at least on pressing unit, a force onto the pieces of wood in a direction transversely to a pressing pressure applied by the at least one pressing unit.

6. The gluing press according to claim 1, further comprising a high frequency heating device.

7. The gluing press according to claim 6, further comprising a clamping device, wherein the high frequency heating device has at least one flat electrode that is secured on the clamping device.

8. The gluing press according to claim 7, wherein the flat electrode is suspended from pressing bars of the clamping device.

9. The gluing press according to claim 8, wherein the flat electrode covers a contact side of the pressing bars.

10. The gluing press according to claim 7, further comprising skirts for shielding radiation of the high frequency heating device, wherein the skirts are provided on the clamping device and shield a pressing area relative to the exterior.

11. The gluing press according to claim 6, wherein the press table is a minus pole of the high frequency heating device.

12. A gluing press for lamella-shaped pieces of wood, the gluing press comprising:
a press table;
a stop for pieces of wood to be press bonded;
at least one pressing unit;
wherein the stop is connected by a plug-in connection to at least one supporting means.

13. The gluing press according to claim 12, further comprising a spindle drive that is drivingly connected to the supporting means.

14. The gluing press according to claim 13, wherein the supporting means comprises at least one spindle nut that is connected to a spindle of the spindle drive.

15. The gluing press according to claim 14, wherein the spindle is arranged underneath a support surface of the press table.

16. The gluing press according to claim 12, wherein the supporting means comprises at least one carriage guided on the press table.

17. The gluing press according to claim 16, wherein the at least one carriage has at least one receptacle for at least one coupling part of the stop.

18. The gluing press according to claim 12, further comprising at least one lifting device connected to the stop.

19. The gluing press according to claim 18, wherein the lifting device comprises at least one lifting cylinder.

20. The gluing press according to claim 19, wherein the lifting cylinder engages a coupling part of the stop.

21. A gluing press for lamella-shaped pieces of wood, the gluing press comprising:
a press table;
a stop for pieces of wood to be press bonded;
at least one pressing unit comprised of pressing elements positioned adjacent to one another and movable to a limited extent relative to one another and opposite to a pressing direction of the at least one pressing unit.

22. The gluing press according to claim 21, wherein a pressing stroke of the pressing elements is several times smaller than an adjustment stroke of the stop.

23. The gluing press according to claim 21, wherein sides of the pressing elements that contact one another have a tongue-and-groove arrangement for engaging one another.

24. The gluing press according to claim 21, wherein the pressing elements are force-loaded on a side of the pressing elements that is facing away from the stop.

25. A gluing press for the lamella-shaped pieces of wood, the gluing press comprising:
a press table;
a stop for pieces of wood to be press bonded;
at least one pressing unit;
at least one elastically deformable body loaded by a pressure medium and connected to the at least one pressing unit for pressure loading the at least one pressing unit.

26. The gluing press according to claim 25, wherein the at least one elastically deformable body is a hose closed at the ends and having at least one connector connecting the hose to a pressure medium source.

27. The gluing press according to claim 25, wherein the elastically deformable body is arranged in a securing rail.

28. The gluing press according to claim 27, wherein the at least one pressing unit comprises pressing elements and wherein the securing rail is a U-shaped part into which the pressing elements project partially.

29. The gluing press according to claim 28, wherein the elastically deformable body is supported on a transverse web of the U-shaped part.

30. A gluing press for lamella-shaped pieces of wood, the gluing press comprising:
a press table;
a stop for pieces of wood to be press bonded;
at least one pressing unit;
at least one clamping device that during pressing by the at least one pressing unit applies a clamping force onto the pieces of wood in a clamping direction transversely to a pressing pressure of the at least one pressing unit, wherein the at least one clamping devices has several pressing bars that are movable to a limited extent relative to one another in the clamping direction.

31. The gluing press according to claim 30, wherein the pressing bars are movable to a limited extent transversely to the camping direction.

32. The gluing press according to claim 30, wherein the clamping device comprises securing rails and wherein the pressing bars are suspended from the securing rails, respectively.

33. The gluing press according to claim 32, wherein the securing rails are profiled rails and wherein the pressing bars each have a securing member engaging one of the profiled rails, respectively.

34. A gluing press for lamella-shaped pieces of wood, the gluing press comprising:
a press table;
a stop for pieces of wood to be press bonded;
at least one pressing unit;
a clamping device comprising pressing bars;
at least one elastically deformable body acting on the pressing bars, wherein the pressing bars are movable against a force generated by the at least one elastically deformable body.

35. The gluing press according to claim 34, wherein the at least one elastically deformable body is a hose closed at the ends.

36. The gluing press according to claim 34, wherein the at least one elastically deformable body is arranged in a holding rail.

37. The gluing press according to claim 34, wherein the at least one elastically deformable body has at least one connector for a pressure medium.

38. The gluing press according to claim 30, wherein the pressing bars have a length matching approximately a length of the press table.

39. The gluing press according to claim 30, wherein the clamping device is adjustable in a clamping direction.

40. A gluing press for lamella-shaped pieces of wood, the gluing press comprising:
a press table;
a stop for pieces of wood to be press bonded;
at least one pressing unit;
a clamping device;
at least one guide connected to the clamping device guiding the clamping device when the clamping device is adjusted.

41. A gluing press according to claim 40, wherein the at least one guide comprises at least one sliding block engaging guiding means of the at least one guide.

42. A gluing press according to claim 40, wherein the guiding means comprise a vertical guide section and an adjoining slanted guide section.

43. The gluing press according to claim 41, wherein the clamping device has at least one vertical support and wherein the at least one guide is provided on the at least one vertical support.

44. The gluing press according to claim 43, wherein the at least one vertical support is vertically adjustable by a spindle drive.

45. The gluing press according to claim 44, wherein the spindle drive comprises a vertical spindle and a spindle nut supported on the vertical spindle and acting on the at least one vertical support.

46. The gluing press according to claim 44, wherein the clamping device comprises a transverse support and two of the vertical supports that are positioned parallel to one another, wherein the two vertical supports are pivotably supported on the transverse support.

47. The gluing press according to claim 46, wherein the transverse support has opposed ends and wherein the spindle drive comprises two spindles each having a spindle nut mounted on a projection, wherein each one of the projections is inserted into one of the opposed ends.

48. The gluing press according to claim 47, wherein the vertical supports each have a slotted hole, wherein the projections each pass through one of the slotted holes, respectively.

49. The gluing press according to claim 44, further comprising a hydromotor, wherein the spindle drive is drivingly connected to the hydromotor.

50. A gluing press for lamella-shaped pieces of wood, the gluing press comprising:
a press table;
a stop for pieces of wood to be press bonded;
at least one pressing unit;
a loading unit arranged upstream of the press table, wherein the loading unit comprises a support table that is horizontally pivotable about a horizontal axis.

51. The gluing press according to claim 50, wherein the support table has a guide for at least one slide.

52. The gluing press according to claim 51, wherein the guide extends across a length of the press table.

53. The gluing press according to claim 51, wherein the slide is pivotable about an axis that is positioned in a moving direction of the slide.

54. The gluing press according to claim 51, wherein the support table when in a non-pivoted position adjoins the press table.

55. A method for press bonding lamella-shaped pieces of wood, the method comprising the steps of:
coating pieces of wood with a glue;
aligning the pieces of wood transversely to a longitudinal direction of the pieces of wood; and
subsequently generating a pressing pressure on the pieces of wood in a direction transversely to the longitudinal direction by applying a pressure medium.

56. The method according to claim 55, wherein the pressure medium is compressed air that is introduced into at least one elastically expandable hose closed at the ends.

57. The method according to claim 55, further comprising the step of heating the pieces of wood with high frequency.

58. A method for press bonding lamella-shaped pieces of wood, the method comprising the steps of:
coating pieces of wood with a glue;
applying a pressing pressure on the pieces of wood in a direction transversely to a longitudinal direction of the pieces of wood;
generating a clamping force on the pieces of wood in a direction transverse to a direction of application of the pressing pressure by employing a pressure medium.

59. The method according to claim 58, wherein the pressure medium is compressed air that is introduced into at least one elastically expandable hose closed at the ends.

60. The method according to claim 58, further comprising the step of heating the pieces of wood with high frequency.

61. The method according to claim 58, wherein the clamping force is generated by pressing bars, wherein the pressing bars and the pieces of wood are moved slightly in the pressing direction at the beginning of pressing.

62. The method according to claim 58, further comprising the step of placing the pieces of wood, after the step of coating, onto a tilted support table of a loading unit.

63. The method according to claim 62, further comprising the step of pushing the pieces of wood by at least one slide from the support table onto a press table of a gluing press.

64. The method according to claim 63, further comprising the step of lifting the slide when returning the slide from the press table to the support table.
